(19) United States
(12) Patent Application Publication
(10) Pub. No.: US 2026/0059626 A1
(43) Pub. Date: Feb. 26, 2026

(54) EFFICIENT, ENERGY-SAVING AND SAFE THREE-COLOR LED CONTROL CIRCUIT

(71) Applicant: Hang LIU, Jingzhou (CN)

(72) Inventor: Hang LIU, Jingzhou (CN)

(21) Appl. No.: 18/882,803

(22) Filed: Sep. 12, 2024

(30) Foreign Application Priority Data
Aug. 23, 2024 (CN) 202422054128.8

(51) Int. Cl. H05B 45/50; H05B 45/325; H05B 45/34; H05B 45/345; H05B 47/175; H05B 47/25

(52) U.S. Cl. CPC H05B 45/50; H05B 45/325; H05B 45/34; H05B 45/345; H05B 47/175; H05B 47/25

(57) ABSTRACT

An efficient, energy-saving, and safe three-color LED control circuit, includes a program control circuit for controlling long turn-on, flicker, breathing flicker, a color change and brightness adjustment by controlling PWM signal output; a three-loop LED drive circuit for providing a stable current and voltage for a three-color LED; a short-circuit protection circuit for timely shutting off a power supply when the three-color LED has a short circuit; a remote-control receiving circuit for receiving a signal of a remote controller; an anti-reverse connection protection circuit of the power supply; and an anti-reverse connection protection circuit of the battery. With a three-loop LED drive circuit design, in the three-color LED, all anodes are connected to a same joint, and all cathodes are not connected to a same joint, and there are only three pins.

### CROSS REFERENCE TO RELATED APPLICATIONS

This application is based upon and claims foreign priority to Chinese Patent Application No. 202422054128.8, filed on Aug. 23, 2024, the entire contents of which are incorporated herein by reference.

### TECHNICAL FIELD

The present invention relates to technical field of circuit controllers, and specifically discloses an efficient, energy-saving, and safe three-color LED control circuit.

### BACKGROUND

A three-color LED, namely, a RGB LED, is a light source including red (Red), green (Green), and blue (Blue) LED chips. Different proportions and intensities of light of the three colors can be controlled to obtain light of multiple colors and brightnesses, to achieve a rich color change effect.

The three-color LED can be controlled in state via a remote-control device or a network connection. An operator can change the color and the brightness of light via a remote controller, wireless communication or an internet connection.

Through retrieval, a patent with an application number of CN202021233533.1 discloses a light control circuit of a RGB three-color LED lamp, including a master control chip with a model of PIC18F87J50. A pin 27, a pin 28, a pin 29, a pin 30, a pin 33 and a pin 34 of the master control chip are each connected to a light control unit circuit, and each light control unit circuit is connected to an LED lamp bead. According to the present invention, lamp beads of different basic colors in the RGB LED lamp are controlled by controlling the MOS transistor to be turned on through a triode, and currents on the lamp beads of different basic colors in the RGB LED lamp are adjusted by changing a PWM parameter, to change the color of the light is changed in a combined manner. The PWM parameter is changed through a simple 485 communication protocol, so that light dimness and the light color are directly changed through a communication packet. This control mode is simple and practical, low in cost, and is suitable for multiple light control occasions.

For a three-color LED on the current market, cathodes are connected to a same joint or anodes are connected to a same joint, and therefore, there are four pins, and four lines are required for output. Compared with a conventional H-bridge circuit drive manner for a dual-color LED control circuit, the dual-color lamp only keeps the two colors on: warm white and seven-color. Only nine functional modes are provided through the dual-color mode, and therefore, an efficient, energy-saving, and safe three-color LED control circuit is needed.

### SUMMARY

An objective of the present invention is to provide an efficient, energy-saving, and safe three-color LED control circuit. With a three-loop LED drive circuit design, in the three-color LED, all anodes are connected to a same joint, and all cathodes are not connected to a same joint, and there are only three pins. In other words, the three-color LED has only three lines, and is more convenient to mount and control. In addition, the three-color LED can keep three colors on: warm white, daylight white, and seven-color. Different modes can be combined based on the three colors to create tens of functional modes, and therefore, the three-color LED is wider in application range, and is more convenient in use, to resolve the problems in the conventional technology.

To achieve the objective, the present invention provides the following technical solution. An efficient, energy-saving, and safe three-color LED control circuit includes:
a program control circuit for controlling long turn-on, flicker, breathing flicker, a color change and brightness adjustment by controlling PWM signal output;
a three-loop LED drive circuit for providing a stable current and voltage for a three-color LED;
a short-circuit protection circuit for timely shutting off a power supply when the three-color LED has a short circuit;
a remote-control receiving circuit for receiving a signal of a remote controller;
an anti-reverse connection protection circuit of the power supply for avoiding a damage to a circuit element when polarity of the power supply is reversed; and
an anti-reverse connection protection circuit of the battery for preventing a damage to the battery when polarity of the battery is reversed, where
the short-circuit protection circuit is electrically connected to the three-loop LED drive circuit, and the three-loop LED drive circuit, the short circuit protection circuit, the remote-control receiving circuit, the anti-reverse connection protection circuit of the power supply, and the anti-reverse connection protection circuit of the battery are all electrically connected to the program control circuit.

Preferably, the program control circuit includes a chip U1, a pin 1 of the chip U1 is connected to a positive electrode of a 5V power supply, a crystal oscillator X1 and a resistor R17 are connected between a pin 2 and a pin 3 of the chip U1, two ends of the crystal oscillator X1 are in parallel connected with a capacitor C7 and a capacitor C8 that are connected in series, a light-emitting diode LED and a resistor R1 are connected between the pin 1 and a pin 4 of the chip U1, and a switch SW for grounding is connected on a pin 7 of the chip U1.

Preferably, the three-loop LED drive circuit includes an MOS transistor Q1, an MOS transistor Q2, an MOS transistor Q3, an MOS transistor Q4, and an MOS transistor Q5, where a light emitting diode CW and a light emitting diode W that are disposed in parallel are separately connected between a source of the MOS transistor Q1 and a terminal of a drain of the MOS transistor Q2, and between a source of the MOS transistor Q3 and a terminal of a drain of the MOS transistor Q4, a light emitting diode RGBY is separately connected between a source of the MOS transistor Q5 and the source of the MOS transistor Q3, and the terminal of the drain of the MOS transistor Q4, and the drain of the MOS transistor Q5 is connected on the pin 1 of the chip U1.

Preferably, a resistor R9 connected on a pin 8 of the chip U1 is connected on a gate of the MOS transistor Q1, a resistor R5 connected on a pin 5 of the chip U1 is connected on a gate of the MOS transistor Q2, a resistor R11 connected on a pin 9 of the chip U1 is connected on a gate of the MOS transistor Q3, a resistor R7 connected on a pin 6 of the chip U1 is connected on a gate of the MOS transistor Q4, and a resistor R3 connected on a pin 11 of the chip U1 is connected on a gate of the MOS transistor Q5.

Preferably, the short-circuit protection circuit includes a resistor R13 and a resistor R14 that are disposed in parallel, a terminal of the resistor R13 and a terminal of the resistor R14 are connected to a terminal of the source of the MOS transistor Q2 and a terminal of the source of the MOS transistor Q4, and a resistor R2 connected on a pin 10 of the chip U1 is connected on the terminal of the resistor R13 and the terminal of the resistor R14.

Preferably, the remote-control receiving circuit includes an infrared receiving chip IR, a pin 1 of the infrared receiving chip IR is connected on a pin 13 of the chip U1, a capacitor C3 is connected between a pin 2 and a pin 3 of the infrared receiving chip IR, and the pin 3 of the infrared receiving chip IR is connected on the pin 1 of the chip U1.

Preferably, the anti-reverse connection protection circuit of the power supply includes a diode D1 and a capacitor C1 that are disposed in parallel, the diode D1 and a terminal at one end of the capacitor C1 are connected on the pin 1 of the chip U1, and the diode D1 and a terminal at the other end of the capacitor C1 are grounded.

Preferably, the anti-reverse connection protection circuit of the battery includes an MOS transistor Q6, a drain of the MOS transistor Q6 is connected to a negative electrode of the power supply, a capacitor C5 and a resistor R16 that are disposed in parallel are connected between a gate and a drain of the MOS transistor Q6, and a resistor R15 connected on the positive electrode of the power supply is connected on the gate of the MOS transistor Q6.

Compared with the prior art, the present invention has the following beneficial effect.

According to the present invention, with a three-loop LED drive circuit design, in the three-color LED, all anodes are connected to a same joint, and all cathodes are not connected to a same joint, and there are only three pins. In other words, the three-color LED has only three lines, and is more convenient to mount and control. In addition, the three-color LED has three colors: warm white, daylight white, and seven-color. Different modes can be combined based on the three colors to create tens of functional modes, and therefore, the three-color LED is wider in application range, and is more convenient in use.

### BRIEF DESCRIPTION OF DRAWINGS

FIG. 1 is a block diagram of a circuit according to the present invention;

FIG. 2 is a circuit diagram of a program control circuit according to the present invention;

FIG. 3 is a circuit diagram of a three-loop LED drive circuit and a short-circuit protection circuit according to the present invention;

FIG. 4 is a circuit diagram of a remote-control receiving circuit according to the present invention;

FIG. 5 is a circuit diagram of an anti-reverse connection protection circuit of the power supply according to the present invention; and

FIG. 6 is a circuit diagram of an anti-reverse connection protection circuit of the battery according to the present invention.

### DETAILED DESCRIPTION OF THE EMBODIMENTS

The following clearly and completely describes the technical solutions in embodiments of this present invention with reference to the accompanying drawings in the embodiments of present invention. Apparently, the described embodiments are merely some rather than all of embodiments of the present invention. All other embodiments obtained by a person of ordinary skill in the art based on embodiments of the present invention fall within the protection scope of the present invention without making creative efforts.

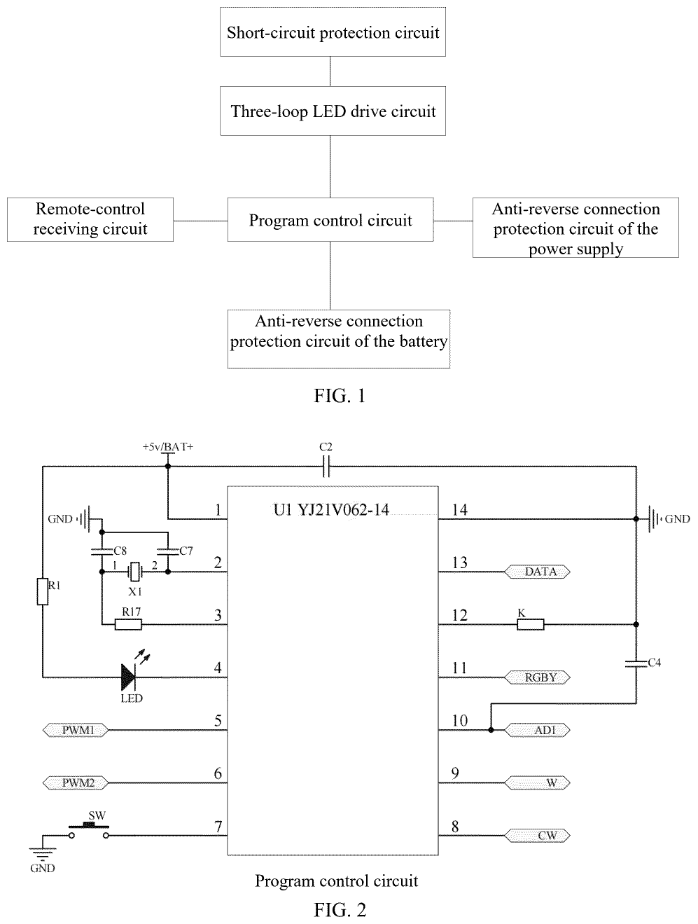

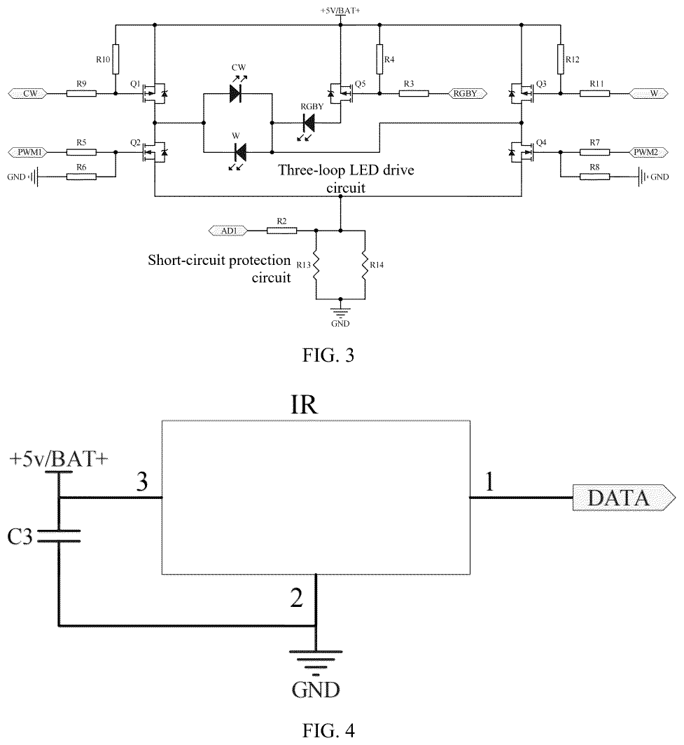

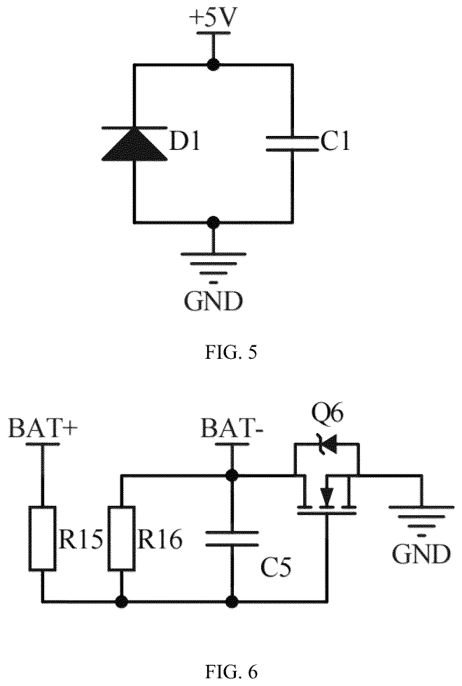

Refer to FIG. 1 to FIG. 6. The present invention provides a technical solution. An efficient, energy-saving, and safe three-color LED control circuit includes:
a program control circuit for controlling long turn-on, flicker, breathing flicker, a color change and brightness adjustment by controlling PWM signal output, where
the program control circuit includes a chip U1, a pin 1 of the chip U1 is connected to a positive electrode of a 5V power supply, a crystal oscillator X1 and a resistor R17 are connected between a pin 2 and a pin 3 of the chip U1, two ends of the crystal oscillator X1 are in parallel connected with a capacitor C7 and a capacitor C8 that are connected in series, a terminal of the capacitor C7 and a terminal of the capacitor C8 are grounded; a light-emitting diode LED and a resistor R1 are connected between the pin 1 and a pin 4 of the chip U1, and a switch SW for grounding is connected on a pin 7 of the chip U1.

A capacitor C4 and a resistor K are connected between a pin 10 and a pin 12 of the chip U1, a capacitor C2 is connected between the pin 1 and the pin 14 of the chip U1, and the capacitor C4 and a terminal of the resistor K are connected on the pin 14 of the chip U1, and are grounded.

A three-loop LED drive circuit for providing a stable current and voltage for a three-color LED is further included, where
the three-loop LED drive circuit includes an MOS transistor Q1, an MOS transistor Q2, an MOS transistor Q3, an MOS transistor Q4, and an MOS transistor Q5, where a light emitting diode CW and a light emitting diode W that are disposed in parallel are separately connected between a source of the MOS transistor Q1 and a terminal of a drain of the MOS transistor Q2, and between a source of the MOS transistor Q3 and a terminal of a drain of the MOS transistor Q4, a light emitting diode RGBY is separately connected between a source of the MOS transistor Q5 and the source of the MOS transistor Q3, and the terminal of the drain of the MOS transistor Q4, and the drain of the MOS transistor Q5 is connected on the pin 1 of the chip U1.

A resistor R9 connected on a pin 8 of the chip U1 is connected on a gate of the MOS transistor Q1, a resistor R5 connected on a pin 5 of the chip U1 is connected on a gate of the MOS transistor Q2, a resistor R11 connected on a pin 9 of the chip U1 is connected on a gate of the MOS transistor Q3, a resistor R7 connected on a pin 6 of the chip U1 is connected on a gate of the MOS transistor Q4, and a resistor R3 connected on a pin 11 of the chip U1 is connected on a gate of the MOS transistor Q5.

A resistor R10 is connected between the gate and the drain of the MOS transistor Q1, a resistor R6 for grounding is connected on the gate of the MOS transistor Q2, a resistor R12 is connected between the gate and a drain of the MOS transistor Q3, a grounding resistor R8 connected on the gate of the resistor R4 is connected between a gate and a drain, a resistor R4 is connected between a gate and a drain of the MOS transistor Q5, and the drain of the MOS transistor Q1 is connected to the drain of the MOS transistor Q3, and is connected on the pin 1 of the chip U1.

A short-circuit protection circuit for timely shutting off a power supply when the three-color LED has a short circuit is further included.

The short-circuit protection circuit includes a resistor R13 and a resistor R14 that are disposed in parallel, a terminal of the resistor R13 and a terminal of the resistor R14 are connected to a terminal of the source of the MOS transistor Q2 and a terminal of the source of the MOS transistor Q4, and a resistor R2 connected on a pin 10 of the chip U1 is connected on the terminal of the resistor R13 and the terminal of the resistor R14.

A remote-control receiving circuit for receiving a signal of a remote controller is further included.

The remote-control receiving circuit includes an infrared receiving chip IR, a pin 1 of the infrared receiving chip IR is connected on a pin 13 of the chip U1, a capacitor C3 is connected between a pin 2 and a pin 3 of the infrared receiving chip IR, and the pin 3 of the infrared receiving chip IR is connected on the pin 1 of the chip U1.

An anti-reverse connection protection circuit of the power supply for avoiding a damage to a circuit element when polarity of the power supply is reversed is further included.

The anti-reverse connection protection circuit of the power supply includes a diode D1 and a capacitor C1 that are disposed in parallel, the diode D1 and a terminal at one end of the capacitor C1 are connected on the pin 1 of the chip U1, and the diode D1 and a terminal at the other end of the capacitor C1 are grounded.

An anti-reverse connection protection circuit of the battery for preventing a damage to the battery when polarity of the battery is reversed is further included.

The short-circuit protection circuit is electrically connected to the three-loop LED drive circuit, and the three-loop LED drive circuit, the short circuit protection circuit, the remote-control receiving circuit, the anti-reverse connection protection circuit of the power supply, and the anti-reverse connection protection circuit of the battery are all electrically connected to the program control circuit.

The anti-reverse connection protection circuit of the battery includes an MOS transistor Q6, a drain of the MOS transistor Q6 is connected to a negative electrode of the power supply, a capacitor C5 and a resistor R16 that are disposed in parallel are connected between a gate and a drain of the MOS transistor Q6, and a resistor R15 connected on the positive electrode of the power supply is connected on the gate of the MOS transistor Q6.

Although the embodiments of the present invention are shown and described, for a person of ordinary skill in the art, various changes, modifications, replacements, and variations may be made to the embodiments without departing from the principles and spirit of the present invention, and the scope of the present invention is as defined by the appended claims and their equivalents.

What is claimed is:

1. An efficient, energy-saving and safe three-color LED control circuit, comprising:
a program control circuit for controlling long turn-on, flicker, breathing flicker, a color change and brightness adjustment by controlling PWM signal output;
a three-loop LED drive circuit for providing a stable current and a stable voltage for a three-color LED;
a short-circuit protection circuit for timely shutting off a power supply when the three-color LED has a short circuit;
a remote-control receiving circuit for receiving a signal of a remote controller;
an anti-reverse connection protection circuit of the power supply for avoiding a damage to a circuit element when polarity of the power supply is reversed; and
an anti-reverse connection protection circuit of the battery for preventing a damage to the battery when polarity of the battery is reversed, wherein
the short-circuit protection circuit is electrically connected to the three-loop LED drive circuit, and the three-loop LED drive circuit, the short circuit protection circuit, the remote-control receiving circuit, the anti-reverse connection protection circuit of the power supply, and the anti-reverse connection protection circuit of the battery are all electrically connected to the program control circuit.

2. The efficient, energy-saving and safe three-color LED control circuit according to claim 1, wherein the program control circuit comprises a chip U1, a pin 1 of the chip U1 is connected to a positive electrode of a 5V power supply, a crystal oscillator X1 and a resistor R17 are connected between a pin 2 and a pin 3 of the chip U1, two ends of the crystal oscillator X1 are in parallel connected with a capacitor C7 and a capacitor C8 that are connected in series, a light-emitting diode LED and a resistor R1 are connected between the pin 1 and a pin 4 of the chip U1, and a switch SW for grounding is connected on a pin 7 of the chip U1.

3. The efficient, energy-saving and safe three-color LED control circuit according to claim 2, wherein the three-loop LED drive circuit comprises an MOS transistor Q1, an MOS transistor Q2, an MOS transistor Q3, an MOS transistor Q4, and an MOS transistor Q5, wherein a light emitting diode CW and a light emitting diode W that are disposed in parallel are separately connected between a source of the MOS transistor Q1 and a terminal of a drain of the MOS transistor Q2, and between a source of the MOS transistor Q3 and a terminal of a drain of the MOS transistor Q4, a light emitting diode RGBY is separately connected between a source of the MOS transistor Q5 and the source of the MOS transistor Q3, and the terminal of the drain of the MOS transistor Q4, and the drain of the MOS transistor Q5 is connected on the pin 1 of the chip U1.

4. The efficient, energy-saving and safe three-color LED control circuit according to claim 3, wherein a resistor R9 connected on a pin 8 of the chip U1 is connected on a gate of the MOS transistor Q1, a resistor R5 connected on a pin 5 of the chip U1 is connected on a gate of the MOS transistor Q2, a resistor R11 connected on a pin 9 of the chip U1 is connected on a gate of the MOS transistor Q3, a resistor R7 connected on a pin 6 of the chip U1 is connected on a gate of the MOS transistor Q4, and a resistor R3 connected on a pin 11 of the chip U1 is connected on a gate of the MOS transistor Q5.

5. The efficient, energy-saving and safe three-color LED control circuit according to claim 4, wherein the short-circuit protection circuit comprises a resistor R13 and a resistor R14 that are disposed in parallel, a terminal of the resistor R13 and a terminal of the resistor R14 are connected to a terminal of the source of the MOS transistor Q2 and a terminal of the source of the MOS transistor Q4, and a resistor R2 connected on a pin 10 of the chip U1 is connected on the terminal of the resistor R13 and the terminal of the resistor R14.

6. The efficient, energy-saving and safe three-color LED control circuit according to claim 5, wherein the remote-control receiving circuit receiving circuit comprises an infrared receiving chip IR, a pin 1 of the infrared receiving chip IR is connected on a pin 13 of the chip U1, a capacitor C3 is connected between a pin 2 and a pin 3 of the infrared receiving chip IR, and the pin 3 of the infrared receiving chip IR is connected on the pin 1 of the chip U1.

7. The efficient, energy-saving and safe three-color LED control circuit according to claim 6, wherein the anti-reverse connection protection circuit of the power supply comprises a diode D1 and a capacitor C1 that are disposed in parallel, the diode D1 and a terminal at one end of the capacitor C1 are connected on the pin 1 of the chip U1, and the diode D1 and a terminal at the other end of the capacitor C1 are grounded.

8. The efficient, energy-saving and safe three-color LED control circuit according to claim 7, wherein the anti-reverse connection protection circuit of the battery comprises an MOS transistor Q6, a drain of the MOS transistor Q6 is connected to a negative electrode of the power supply, a capacitor C5 and a resistor R16 that are disposed in parallel are connected between a gate and a drain of the MOS transistor Q6, and a resistor R15 connected on the positive electrode of the power supply is connected on the gate of the MOS transistor Q6.
